(19) United States
(12) Patent Application Publication
(10) Pub. No.: US 2018/0213203 A1
(43) Pub. Date: Jul. 26, 2018

(54) IMAGE ACQUISITION SYSTEM

(71) Applicant: OLYMPUS CORPORATION, Tokyo (JP)

(72) Inventor: Naoyuki Miyashita, Saitama (JP)

(73) Assignee: OLYMPUS CORPORATION, Tokyo (JP)

(21) Appl. No.: 15/927,010

(22) Filed: Mar. 20, 2018

Related U.S. Application Data
(63) Continuation of application No. PCT/JP2015/080851, filed on Oct. 30, 2015.

(51) Int. Cl. H04N 13/00; H04N 7/18; G06T 7/00

(52) U.S. Cl. CPC H04N 13/0048; H04N 7/181; H04N 13/0011; G06T 7/97; H04N 13/0062; H04N 13/0203; H04N 13/0051

(57) ABSTRACT

An image acquisition system is provided with: an image acquisition unit that captures a subject; a 3D-information obtaining unit that obtains 3D information of the subject to configure a virtual subject in a virtual space; a virtual-angle generating unit that generates, as a virtual angle, virtual position and orientation of the image acquisition unit with respect to the virtual subject, which is obtained by the 3D-information obtaining unit; a virtual-image generating unit that generates a virtual acquisition image that is acquired when the subject is captured from the virtual angle, which is generated by the virtual-angle generating unit; and a display unit that displays the virtual acquisition image, which is generated by the virtual-image generating unit.

### CROSS-REFERENCE TO RELATED APPLICATIONS

This is a continuation of International Application PCT/JP2015/080851, with an international filing date of Oct. 30, 2015, which is hereby incorporated by reference herein in its entirety.

### TECHNICAL FIELD

The present invention relates to an image acquisition system.

### BACKGROUND ART

There is a known camera that recognizes the type of a subject and that displays a composition guide appropriate for the type, on an image of the subject displayed on a monitor (for example, see PTL 1).

The technique of PTL 1 processes an acquired image to provide a composition guide or a trimming image.

### CITATION LIST

### Patent Literature

{PTL 1} Japanese Unexamined Patent Application, Publication No. 2011-223599

### SUMMARY OF INVENTION

According to one aspect, the present invention provides an image acquisition system including: an image acquisition unit that captures a subject; a 3D-information obtaining unit that obtains 3D information of the subject to configure a virtual subject in a virtual space; a virtual-angle generating unit that generates, as a virtual angle, virtual position and orientation of the image acquisition unit with respect to the virtual subject, which is configured by the 3D-information obtaining unit; a virtual-image generating unit that generates a virtual acquisition image that is acquired when the subject is captured from the virtual angle, which is generated by the virtual-angle generating unit; and a display unit that displays the virtual acquisition image, which is generated by the virtual-image generating unit.

### BRIEF DESCRIPTION OF DRAWINGS

FIG. 1 is a view showing the overall configuration of an image acquisition system according to one embodiment of the present invention.

FIG. 2 is a table showing an example subject type and reference angles stored in a database unit of the image acquisition system shown in FIG. 1.

FIG. 3 is a table showing a case in which the reference angles have angular ranges, as a modification of FIG. 2.

FIG. 4 is a schematic view showing example determination performed by a virtual-angle determining unit of the image acquisition system shown in FIG. 1.

FIG. 5 is a schematic view showing a case in which there is an obstacle near a virtual image-acquisition unit, as a modification of FIG. 4.

FIG. 6 is a schematic view showing a case in which a subject is a huge structure, as a modification of FIG. 4.

FIG. 7 is a view showing a case in which acquired images are displayed on a display unit of the image acquisition system shown in FIG. 1.

FIG. 8 is a flowchart showing an image acquisition method using the image acquisition system shown in FIG. 1.

FIG. 9 is a view showing the overall configuration of a modification of the image acquisition system shown in FIG. 1.

FIG. 10 is a schematic view showing a case in which 3D information of a subject is generated by using an image acquisition system shown in FIG. 9.

FIG. 11 is a view showing the overall configuration of a modification of the image acquisition system shown in FIG. 9.

FIG. 12 is a schematic view showing a case in which a huge structure is captured as a subject by using an image acquisition system shown in FIG. 11.

FIG. 13A is a view showing an image acquired by capturing the subject from a virtual angle A shown in FIG. 12.

FIG. 13B is a view showing an image acquired by capturing the subject from a virtual angle B shown in FIG. 12.

FIG. 13C is a view showing an image acquired by capturing the subject from a virtual angle C shown in FIG. 12.

FIG. 14 is a schematic view showing a case in which image acquisition is performed from one side with respect to the subject by using the image acquisition system shown in FIG. 11.

FIG. 15 is a schematic view showing a case in which the subject is captured by means of an image acquisition unit at a real angle and an image acquisition unit at a virtual-angle candidate, by using the image acquisition system shown in FIG. 11.

FIG. 16 is a view showing a case in which the direction of movement of the image acquisition unit is schematically shown on the display unit by using a change information generating unit.

FIG. 17 is a view showing a case in which the direction of movement of the image acquisition unit is schematically shown on the display unit by using an angle-change guiding unit.

### DESCRIPTION OF EMBODIMENTS

An image acquisition system 1 according to one embodiment of the present invention will be described below with reference to the drawings.

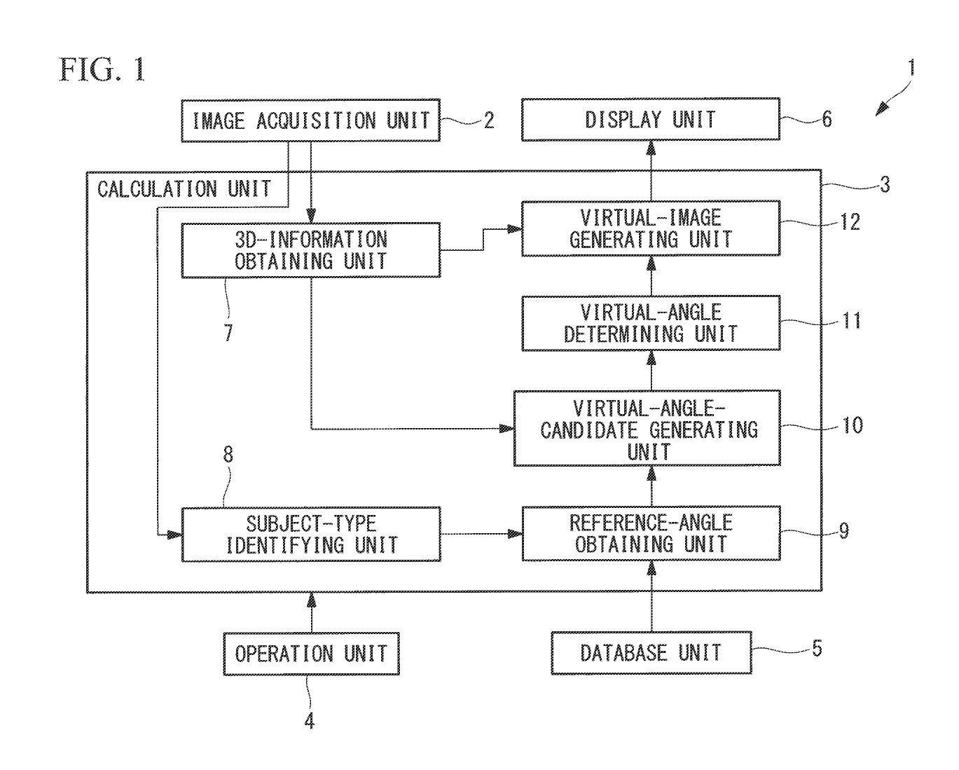

As shown in FIG. 1, the image acquisition system 1 of this embodiment is provided with: an image acquisition unit 2 that acquires an image of a subject; a calculation unit 3 that processes the image acquired by the image acquisition unit 2; an operation unit 4 with which an input for instructing the calculation unit 3 to perform processing is performed; a database unit 5 that stores information set in advance; and a display unit 6 that displays an image etc. processed by the calculation unit 3.

The image acquisition system 1 is a camera.

The image acquisition unit 2 is an imaging device, such as a CCD or CMOS imaging device.

The calculation unit 3 is provided with: a 3D-information obtaining unit 7 that configures a 3D virtual subject in a 3D virtual space; a subject-type identifying unit 8 that identifies the type of a subject; a reference-angle obtaining unit 9 that obtains a reference angle from the database unit 5; a virtual-angle-candidate generating unit (virtual-angle generating unit) 10 that generates a virtual-angle candidate on the basis of the obtained reference angle; a virtual-angle determining unit 11 that determines whether capturing can be performed with the generated virtual-angle candidate; and a virtual-image generating unit 12 that generates a virtual acquisition image that is acquired when the subject is captured from the virtual-angle candidate that it is determined that capturing can be performed for.

The 3D-information obtaining unit 7 receives a plurality of images of a subject that are acquired in time series by the image acquisition unit 2 and obtains, from the received image group, 3D information, such as a 3D point group and texture information of a subject A, the position and the orientation of the image acquisition unit 2, a real scale of the subject, etc. by using the SLAM (Simultaneous Localization And Mapping) technique. Furthermore, although SLAM is used as an example in the present invention, it is also possible to use another technique if equivalent 3D information can be obtained with the technique.

The subject-type identifying unit 8 applies image processing to the image of the subject acquired by the image acquisition unit 2 to extract a feature quantity thereof and identifies the type of the subject on the basis of the feature quantity. Example types of subjects include food, flowers, buildings, and people. Note that a generally known image identification technique may be used as the identification technique.

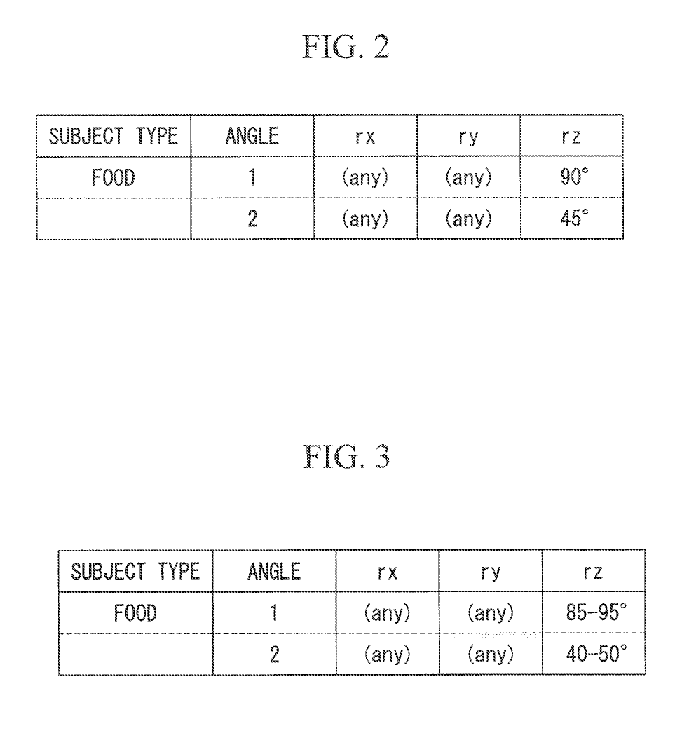

As shown in FIG. 2, for example, the database unit 5 stores the subject type and at least one suitable reference angle (suitable angle of the camera with respect to a subject in the 3D virtual space), in an associated manner. When the type of the subject identified by the subject-type identifying unit 8 is input, at least one reference angle that is stored in association with the input type is output. As shown in FIG. 3, the reference angle may have an angular range.

The virtual-angle-candidate generating unit 10 calculates a virtual position, orientation, and angle of view of the image acquisition unit 2 disposed in the 3D virtual space, on the basis of the reference angle output from the database unit 5. When two or more reference angles are output from the database unit 5, a plurality of prioritized virtual-angle candidates are generated. As the order of priority, a defined order in the database unit 5 or an order of priority separately prescribed in the database unit 5 can be adopted.

The virtual-angle determining unit 11 determines whether capturing can be performed at a virtual angle, by using at least one of the position of a subject, the size thereof, the movable range of the image acquisition system 1, and the angle of view at which capturing is possible.

Determination is performed as follows, for example.

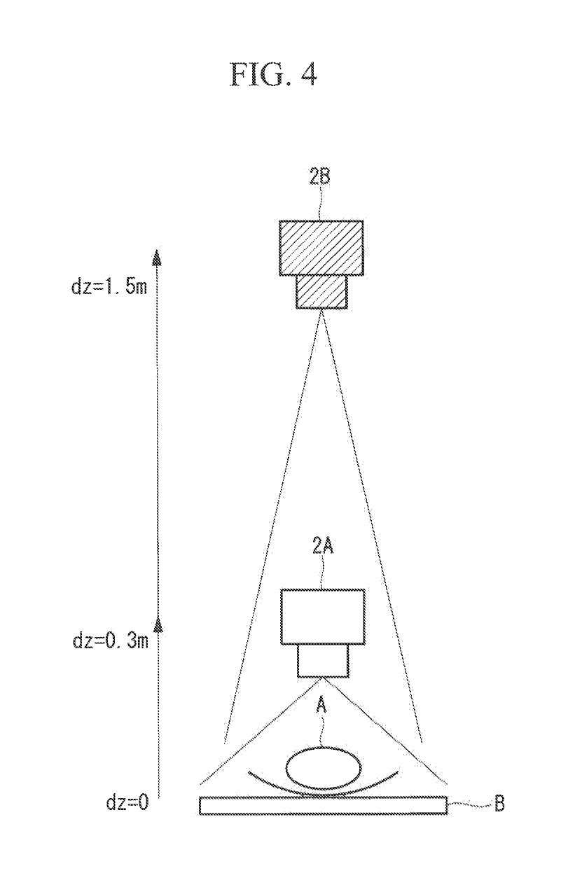

As shown in FIG. 4, when a virtual image-acquisition unit 2A is disposed at a certain virtual-angle candidate, the height distance dz with respect to the subject A is equal to 0.3 m, and the focal length (the size of the angle of view) f is equal to 24 mm, and the focal length f of a real image acquisition unit 2B is equal to 120 mm, if capturing is performed by the real image acquisition unit 2B by using an angle and an angle of view equivalent to those of the virtual image-acquisition unit 2A, the height distance dz of the real image acquisition unit 2B is calculated to be 1.5 m (0.3 m×120 mm/24 mm=1.5 m). In a case in which the subject A is food, and the image acquisition unit 2B is a hand-held camera, it is difficult to hold the image acquisition unit 2B at a position 1.5 m above the subject A placed on a table B, thus making it possible to determine that capturing cannot be performed at this virtual angle.

However, if the focal length of the real image acquisition unit 2B is equivalent to the focal length of the virtual image-acquisition unit 2A, it is possible to determine that capturing can be performed.

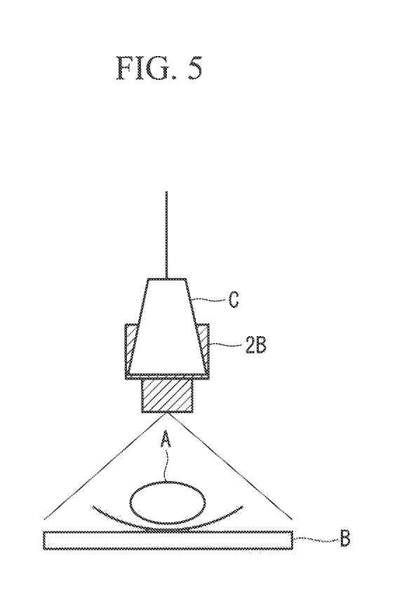

Furthermore, for example, as shown in FIG. 5, if there is an obstacle (for example, a lamp C) in the vicinity of the virtual image-acquisition unit 2A disposed at a virtual angle in the 3D virtual space, it is difficult to dispose the real image acquisition unit 2B at the virtual angle, thus making it possible to determine that capturing cannot be performed. In this way, in the virtual-angle determination, a determination can be made in consideration of 3D information on the surrounding environment of the subject.

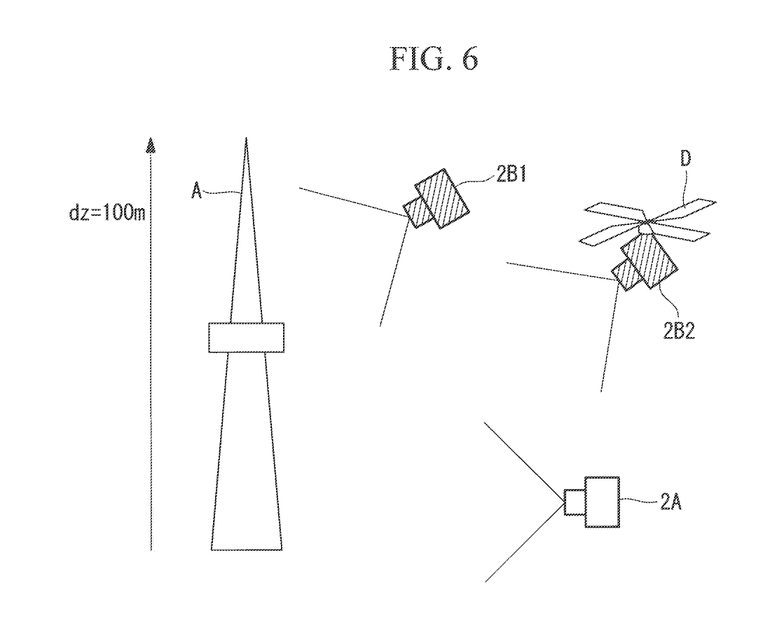

Furthermore, as shown in FIG. 6, in a case in which the identified subject A is a huge structure, if a real image acquisition unit 2B1 is a hand-held camera, because the movable range of the camera is limited, it is determined that capturing cannot be performed, but, if a real image acquisition unit 2B2 is mounted on a flight vehicle D, such as a drone, because the movable range is expanded, it is determined that capturing can be performed.

Therefore, in the virtual-angle determining unit 11, a determination can also be made in consideration of the type of the image acquisition unit 2. The types of the image acquisition unit 2 can be a camera that is hand-held, tripod-mounted, selfie-stick-mounted, drone-mounted, etc.

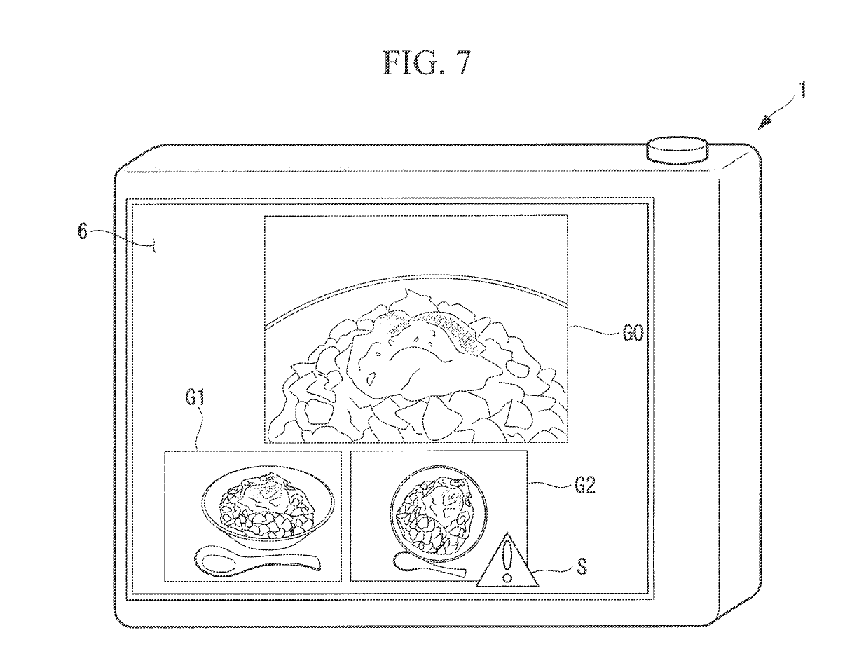

As shown in FIG. 7, the virtual-image generating unit 12 generates, as a virtual acquisition image G1, an image that is acquired when a virtual subject is captured in the 3D virtual space by using a virtual angle that it has been determined, in the virtual-angle determining unit 11, that capturing can be performed for. Note that the virtual-image generating unit 12 also generates, as a virtual acquisition image G2, an image that is acquired when the virtual subject is captured in the 3D virtual space by using a virtual angle that it has been determined that capturing cannot be performed for, and superimposes a letter, a symbol, or the like indicating that capturing cannot be performed (for example, an exclamation mark S shown in FIG. 7) partially on the virtual acquisition image G2. In the figure, reference symbol G0 denotes a live image acquired by the image acquisition unit 2.

The operation of the thus-configured image acquisition system 1 of this embodiment will be described below.

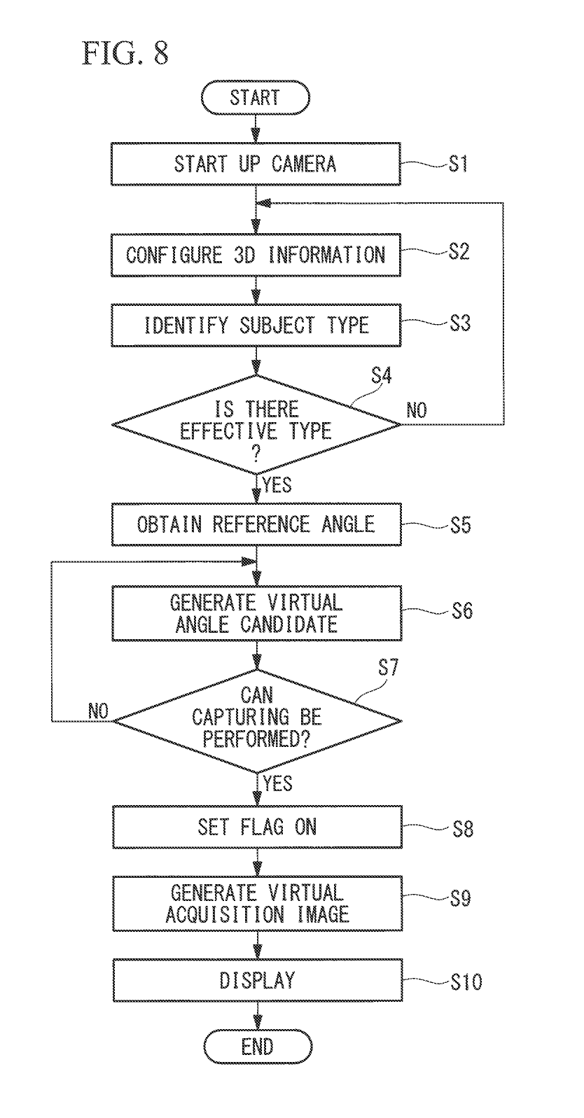

In order to acquire images by using the image acquisition system 1 of this embodiment, as shown in FIG. 8, when the user holds the image acquisition system 1, which is formed of a hand-held camera, and captures the subject A, a plurality of images of the subject A are acquired in time series (Step S1) and are input to the calculation unit 3.

In the calculation unit 3, the 3D-information obtaining unit 7 configures a virtual subject in the 3D virtual space from the plurality of images of the subject A (Step S2), and the subject-type identifying unit 8 identifies the type of the subject A (Step S3).

If an effective type of the subject A is identified (Step S4), the reference-angle obtaining unit 9 searches the database unit 5 by using the identified type and reads out a reference angle that is recorded in association with this type (Step S5).

If the reference angle is read out, the virtual-angle-candidate generating unit 10 generates a virtual-angle candidate on the basis of the obtained reference angle (Step S6), and the virtual-angle determining unit 11 determines whether or not capturing can be performed with the generated virtual-angle candidate (Step S7).

If capturing cannot be performed, a flag is set to ON (Step S8).

Then, the virtual-image generating unit 12 generates, on the basis of the virtual-angle candidate, a virtual acquisition image that is acquired when the virtual subject is captured in the 3D virtual space (Step S9) and displays the virtual acquisition image on the display unit 6 (Step S10).

In this case, in the virtual acquisition image displayed on the display unit 6, whether or not capturing can be performed is displayed in a distinguished manner.

By means of the virtual acquisition images using the subject A being actually captured, the user is clearly informed, before the user actually moves the image acquisition system 1, that a more suitable image can be acquired by capturing the subject A from an angle different from the current angle. Furthermore, there is an advantage in that, even if capturing cannot be performed, it is possible to provide notification of being able to acquire a more suitable image when an obstacle is removed.

Note that, in this embodiment, a virtual acquisition image is generated and displayed when a reference angle is read from the database unit 5; however, when a reference angle is detected in the database unit 5, it is also possible to inform the user to that effect and to generate a virtual acquisition image in response to an instruction from the user.

Furthermore, in this embodiment, although the virtual-angle determining unit 11 determines whether capturing can be performed at a virtual angle, by using at least one of the position of the subject A, the size thereof, the movable range of the image acquisition unit 2, and the angle of view at which capturing is possible, it is also possible to define a criterion for determination in preference to the type of a subject.

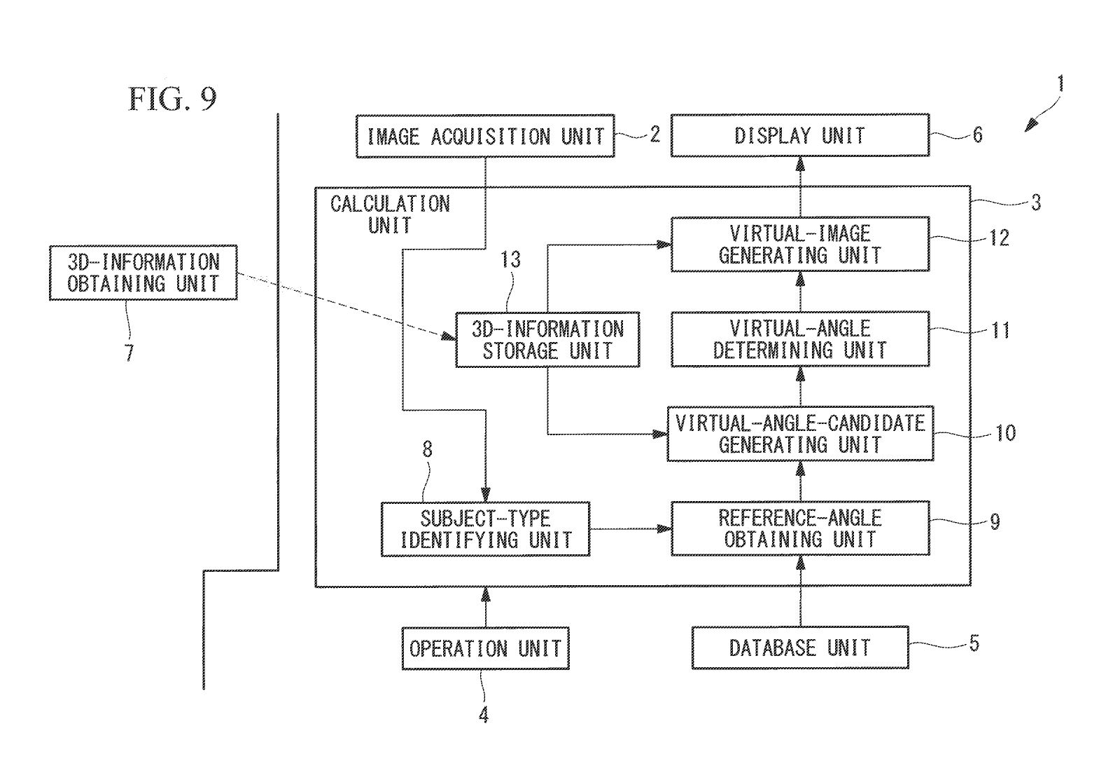

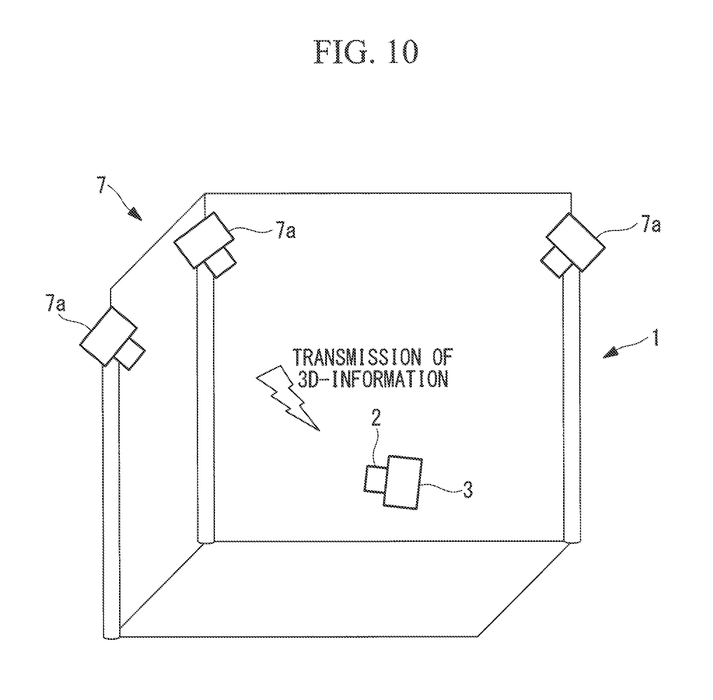

Furthermore, in this embodiment, although 3D information of the subject A is generated on the basis of a plurality of images acquired in time series by the image acquisition unit 2, instead of this, it is also possible to generate 3D information of the subject A on the basis of images acquired by a different device from the image acquisition unit 2. As shown in FIGS. 9 and 10, 3D information may be obtained by, as the different device, a 3D-information obtaining unit 7 that is composed of a plurality of 3D sensors 7a disposed near the ceiling, for example, of a room in which the subject A is disposed, may be sent to the calculation unit 3, and may be stored in a 3D-information storage unit 13. Alternately, 3D information may be obtained on the basis of images acquired by the image acquisition unit 2 mounted on a flight vehicle, such as a drone. Furthermore, the image acquisition unit 2 may be provided with an active 3D sensor of a TOF (Time Of Flight) technique, for example.

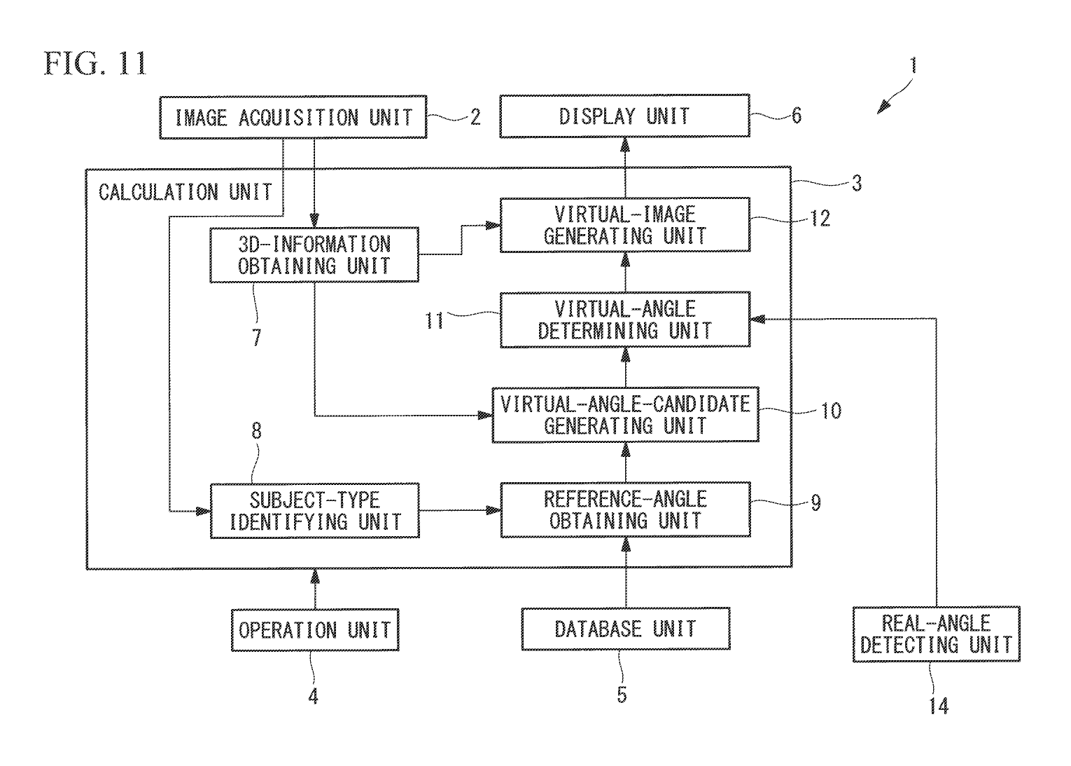

Furthermore, as shown in FIG. 11, it is also possible to further include a real-angle detecting unit 14 that detects the real angle of the image acquisition unit 2 and to display, on the display unit 6, virtual acquisition images in order of increasing difference between a plurality of virtual angles and the real angle (from the virtual angle closest to the real angle).

For example, the difference between the virtual angle A and the real angle a can be calculated as follows.

Dif(α, A)=(coef D×Distance)+(coef A×Angle)

where, Dif(α, A) indicates the difference between the real angle α and the virtual angle A, Distance indicates the distance from the real angle α to the virtual angle A, Angle indicates the angle from the real angle α to the virtual angle A, and coef D and coef A indicate predetermined coefficients.

Furthermore, Distance and Angle from the real angle α to the virtual angle A are calculated as follows.

Distance=|αx−Ax|+|αy−Ay|+|αz−Az|

Angle=|αrx−Arx|+|αry−Ary|+|αrz−Arz|

where, αx, αy, and αz indicate the position obtained by projecting the position of the real angle α onto the 3D virtual space, and αrx, αry, and αrz indicate the orientation of the real angle α. Furthermore, Ax, Ay, and Az indicate the position of the virtual angle A in the 3D virtual space, and Arx, Ary, and Arz indicate the orientation of the virtual angle A.

The real-angle detecting unit 14 may perform detection by using the position and the orientation of the image acquisition unit 2 in the latest frame, which are identified through SLAM, or may use GPS or a gyroscope.

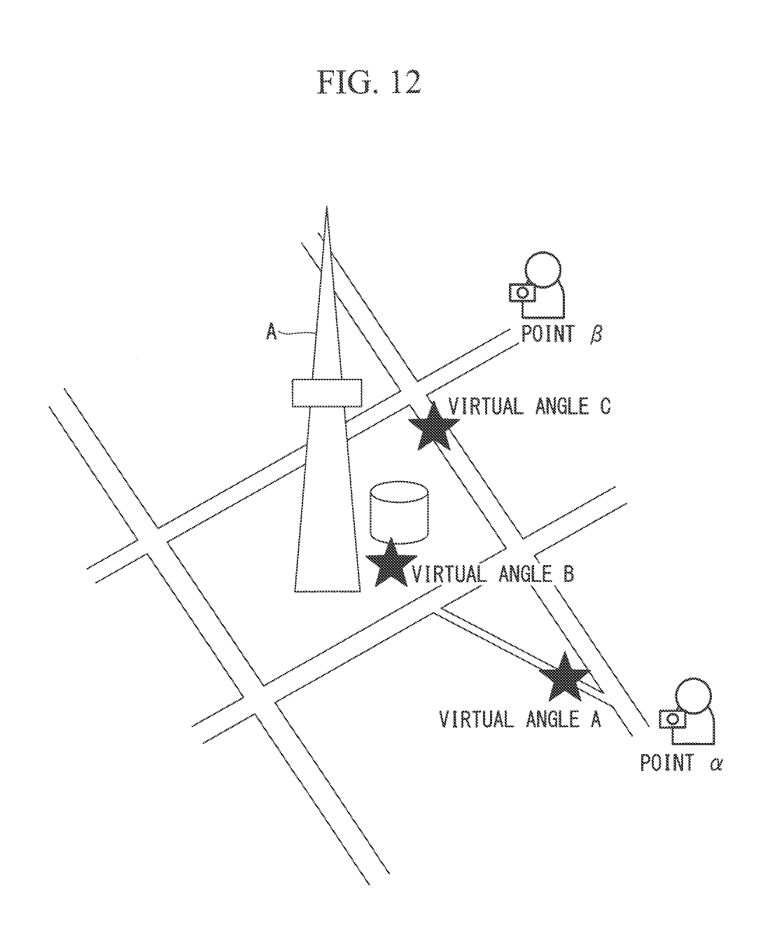

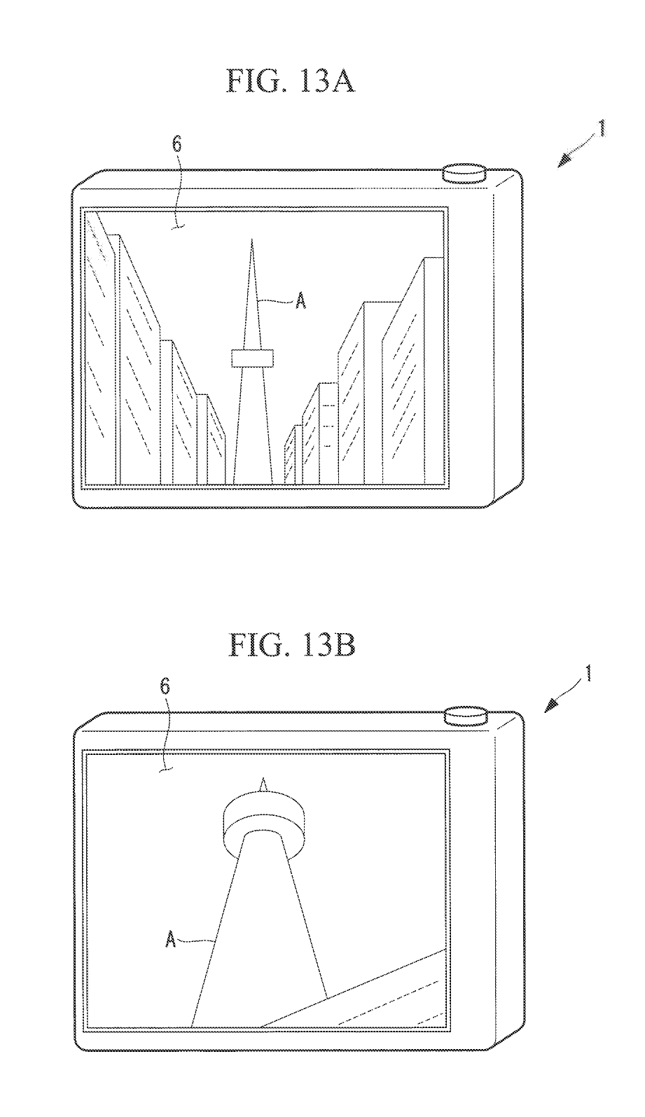

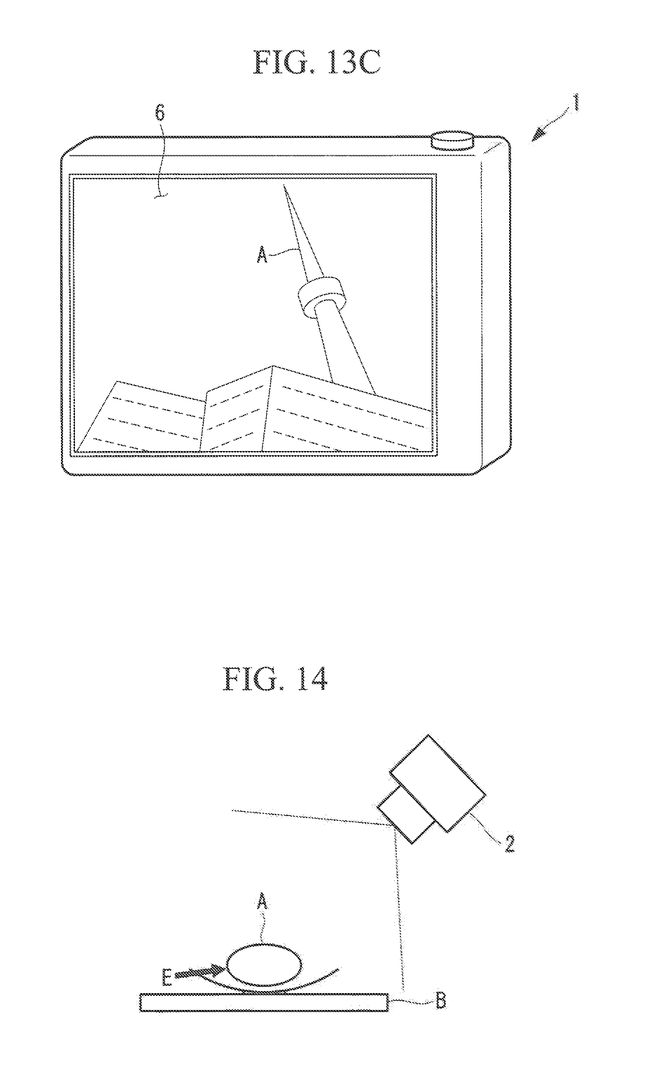

For example, when a huge structure, such as a tower, is set as the subject A, and the user is located at a point α, as shown in FIG. 12, virtual acquisition images shown in FIGS. 13A to 13C are displayed in the order of virtual angles A, B, and C, and, when the user is located at a point β, virtual acquisition images are displayed in the order of the virtual angles C, B, and A.

Because virtual acquisition images are displayed sequentially from the position closest to the image acquisition system 1 held by the user, it is possible to cause the user to move along a particular route, as a result.

Although an example case in which a huge structure is set as the subject A is shown, instead of this, it is also possible to apply the present invention to a route guide for reaching a particular place from the entrance of a building, an endoscope insertion guide, a check point guide for parts inspection for a machine in a factory, etc.

Furthermore, in the above-described embodiment, although an example case in which sufficient 3D information of the subject A can be obtained, thus completely configuring a virtual subject, is shown, for example, as shown in FIG. 14, when 3D information is obtained through SLAM on the basis of only an image acquired from one side of the subject A, because 3D information on a side from which capturing is not performed (side indicated by an arrow E) is not obtained, there is a case in which a virtual subject is not completely configured.

In such a case, even when a reference angle is read from the database unit 5, a virtual acquisition image generated on the basis of a virtual angle corresponding to this reference angle is incomplete, it is preferred that this virtual acquisition image be excluded from images to be displayed by the display unit 6. Therefore, for each of the read reference angles, the configuration percentage of a virtual subject viewed from a virtual angle corresponding to the reference angle is calculated, and a reference angle with which the configuration percentage is equal to or lower than a predetermined value is excluded.

Furthermore, instead of excluding a reference angle with which the configuration percentage is equal to or lower than the predetermined value, it is also possible to store a 3D model in advance in the database unit 5 in association with the type of the subject A and to apply the 3D model to the virtual subject, thereby configuring a virtual subject in which an unconfigured portion thereof has been interpolated.

For example, when the subject A is food on a dish, a round 3D model is stored in advance, and a virtual subject for an unconfigured portion of the dish is interpolated with the 3D model and is generated. Furthermore, when the subject A is a huge structure, the back side of the subject A is interpolated with a 3D model, thus making it possible to configure an virtual subject.

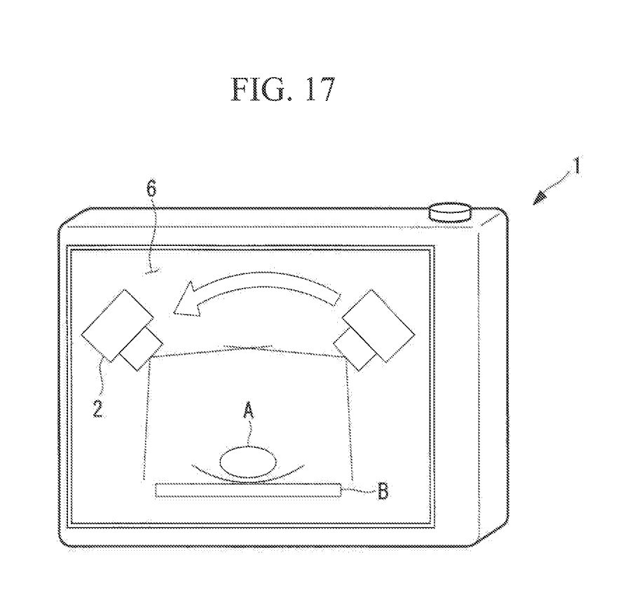

Furthermore, in a case in which a virtual subject is not completely configured due to missing 3D information for the virtual subject through image acquisition shown in FIG. 14, the image acquisition system 1 may use an angle-change guiding unit (not shown) to prompt a change to a real angle. When there is missing 3D information in the 3D information for the virtual subject, which is obtained by the 3D-information obtaining unit 7, the angle-change guiding unit prompts a change to a real angle for interpolating the missing 3D information. Accordingly, the direction of movement of the image acquisition unit 2 for approaching a virtual-angle candidate from the real angle can be presented to the user by schematically displaying the direction on the display unit 6, as shown in FIG. 17.

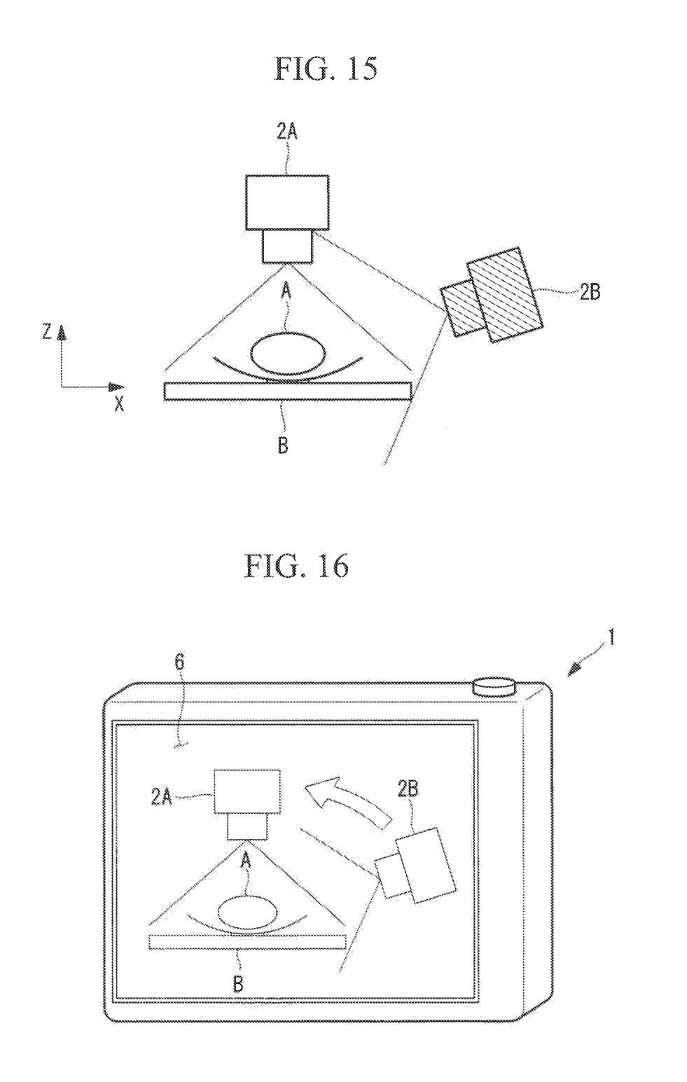

Furthermore, when the image acquisition unit 2B at a real angle detected by the real-angle detecting unit 14 and the image acquisition unit 2A at a virtual-angle candidate generated from a reference angle have the positional relation shown in FIG. 15, the image acquisition system 1 may use a change information generating unit (not shown) to prompt a change in the angle of the image acquisition unit 2B at the real angle. The change information generating unit generates information about the direction in which the angle of the image acquisition unit 2B at the real angle is to be changed, on the basis of the real angle detected by the real-angle detecting unit 14 and the virtual angle generated by the virtual-angle-candidate generating unit 10. Accordingly, as shown in FIG. 16, the direction of movement of the image acquisition unit 2B at the real angle, for approaching the virtual-angle candidate from the real angle, is schematically displayed on the display unit 6, thus making it possible to prompt the user to acquire an image.

From the above-described embodiments and modifications thereof, the following aspects of the invention are derived.

According to one aspect, the present invention provides an image acquisition system including: an image acquisition unit that captures a subject; a 3D-information obtaining unit that obtains 3D information of the subject to configure a virtual subject in a virtual space; a virtual-angle generating unit that generates, as a virtual angle, virtual position and orientation of the image acquisition unit with respect to the virtual subject, which is configured by the 3D-information obtaining unit; a virtual-image generating unit that generates a virtual acquisition image that is acquired when the subject is captured from the virtual angle, which is generated by the virtual-angle generating unit; and a display unit that displays the virtual acquisition image, which is generated by the virtual-image generating unit.

According to this aspect, the 3D-information obtaining unit obtains 3D information of a subject and configures a 3D model of a virtual subject in a virtual space. Then, as a virtual angle, the virtual-angle generating unit generates the position and the orientation of the image acquisition unit with respect to the 3D model of the virtual subject, and the virtual-image generating unit generates a virtual acquisition image that is acquired when the subject is captured from the generated virtual angle. The generated virtual acquisition image is displayed on the display unit.

Specifically, a virtual acquisition image of the subject itself being captured, from a virtual angle different from the real angle of the image acquisition unit, which is used to capture the subject, is displayed on the display unit, thereby making it possible to suggest that an image suitable for the subject can be acquired by changing the angle.

For example, although one of the preferred angles for capturing food is capturing from directly above, it is difficult to get a user who captures food obliquely from above to recognize the effectiveness thereof. According to this aspect, a virtual acquisition image is generated by using an angle from directly above as a virtual angle and is displayed on the display unit, thereby making it possible to effectively show that the angle from directly above is suitable for the subject being captured.

The above-described aspect may further include a virtual-angle determining unit that determines whether or not capturing can be performed at the virtual angle, which is generated by the virtual-angle generating unit, wherein the virtual-image generating unit may generate the virtual acquisition image when the virtual-angle determining unit determines that capturing can be performed.

By doing so, it is possible to suggest an angle at which capturing can be performed, to prompt the user to change the angle.

The above-described aspect may further include a virtual-angle determining unit that determines whether or not capturing can be performed at the virtual angle, which is generated by the virtual-angle generating unit, wherein the display unit may perform display differently for a case in which the virtual-angle determining unit determines that capturing can be performed and a case in which the virtual-angle determining unit determines that capturing cannot be performed.

By doing so, when it is indicated that capturing can be performed, the user can actually change the angle and acquire a suitable image, and, when it is indicated that capturing cannot be performed, it is possible to make the user aware of an effect due to a change in the angle.

In the above-described aspect, the virtual-angle determining unit may make a determination on the basis of at least one of the position of the subject, the size thereof, the movable range of the image acquisition unit, and the angle of view at which capturing is possible.

By doing so, whether capturing can be performed by changing the angle can be easily determined by using at least one of the position of the subject, the size thereof, the movable range of the image acquisition unit, and the angle of view at which capturing is possible. For example, when the subject is a huge structure, such as a tower or a high building, it can be determined that the subject cannot be captured from directly above if the image acquisition unit is of a hand-held type, whereas, it can be determined that capturing can be performed if the image acquisition unit is mounted on a flight vehicle, such as a drone.

The above-described aspect may further include a subject-type identifying unit that identifies the type of the subject captured by the image acquisition unit, wherein the virtual-angle generating unit may generate the virtual angle on the basis of a reference angle that is set in advance according to the type of the subject, which is identified by the subject-type identifying unit.

By doing so, by merely storing an angle suitable for the subject as a reference angle in association with the subject, it is possible to clearly suggest to the user a suitable angle for the type of the subject, which is identified by the subject-type identifying unit.

The above-described aspect may further include a real-angle detecting unit that detects a real angle of the image acquisition unit, wherein the virtual-angle generating unit may generate the virtual angle sequentially from a reference angle that is closer to the real angle, among a plurality of reference angles set in advance.

By doing so, when the angle is changed from the real angle, which is the current angle of the image acquisition unit, to a next virtual angle, virtual angles are generated in order of ease of change. Accordingly, all reference angles can be efficiently confirmed by the user.

In the above-described aspect, if there is missing 3D information in the 3D information for the virtual subject, which is obtained by the 3D-information obtaining unit, the virtual-image generating unit may generate the virtual acquisition image by applying a three-dimensional shape model that is defined in advance according to the type of the subject.

By doing so, even when there is missing 3D information in the 3D information for the virtual subject, a three-dimensional shape model that is defined in advance according to the type of the subject is applied to generate a virtual acquisition image in which an unconfigured portion of the 3D information has been interpolated, thereby making it possible to reduce a sense of incongruity imparted to the user.

The above-described aspect may further include an angle-change guiding unit that prompts, if there is missing 3D information in the 3D information for the virtual subject, which is obtained by the 3D-information obtaining unit, a change to a real angle for interpolating the missing 3D information.

By doing so, in response to the angle-change guiding unit, the user changes the angle to a real angle at which 3D information for interpolating missing 3D information can be obtained, thereby making it possible to obtain the missing 3D information and to generate a complete virtual acquisition image.

The above-described aspect may further include a change information generating unit that generates information about the direction in which the angle of the image acquisition unit is changed, on the basis of the real angle, which is detected by the real-angle detecting unit, and the virtual angle, which is generated by the virtual-angle generating unit, and that displays the generated information on the display unit.

By doing so, because the information about an angle change direction, which is generated by the change information generating unit, is displayed on the display unit, the user changes the angle according to the displayed information, thereby making it possible to easily acquire an image from a suitable angle.

According to the present invention, an advantageous effect is afforded in that capturing at an angle suitable for a subject can be guided by using the same subject as the subject being captured.

### REFERENCE SIGNS LIST

1 image acquisition system
2, 2A, 2B, 2B1, 2B2 image acquisition unit
6 display unit
7 3D-information obtaining unit
8 subject-type identifying unit
10 virtual-angle-candidate generating unit (virtual-angle generating unit)
11 virtual-angle determining unit
12 virtual-image generating unit
14 real-angle detecting unit
A subject

1. An image acquisition system comprising:
an image acquisition unit that captures a subject;
a 3D-information obtaining unit that obtains 3D information of the subject to configure a virtual subject in a virtual space;
a virtual-angle generating unit that generates, as a virtual angle, virtual position and orientation of the image acquisition unit with respect to the virtual subject, which is configured by the 3D-information obtaining unit;
a virtual-image generating unit that generates a virtual acquisition image that is acquired when the subject is captured from the virtual angle, which is generated by the virtual-angle generating unit; and
a display unit that displays the virtual acquisition image, which is generated by the virtual-image generating unit.

2. An image acquisition system according to claim 1, further comprising a virtual-angle determining unit that determines whether or not capturing can be performed at the virtual angle, which is generated by the virtual-angle generating unit,
wherein the virtual-image generating unit generates the virtual acquisition image when the virtual-angle determining unit determines that capturing can be performed.

3. An image acquisition system according to claim 1, further comprising a virtual-angle determining unit that determines whether or not capturing can be performed at the virtual angle, which is generated by the virtual-angle generating unit,
wherein the display unit performs display differently for a case in which the virtual-angle determining unit determines that capturing can be performed and a case in which the virtual-angle determining unit determines that capturing cannot be performed.

4. An image acquisition system according to claim 1, wherein the virtual-angle determining unit makes a determination on the basis of at least one of the position of the subject, the size thereof, the movable range of the image acquisition unit, and the angle of view at which capturing is possible.

5. An image acquisition system according to claim 1, further comprising a subject-type identifying unit that identifies the type of the subject caputured by the image acquisition unit, wherein the virtual-angle generating unit generates the virtual angle on the basis of a reference angle that is set in advance according to the type of the subject, which is identified by the subject-type identifying unit.

6. An image acquisition system according to claim 5, further comprising a real-angle detecting unit that detects a real angle of the image acquisition unit,
wherein the virtual-angle generating unit generates the virtual angle sequentially from a reference angle that is closer to the real angle, among a plurality of reference angles set in advance.

7. An image acquisition system according to claim 5, wherein, if there is missing 3D information in the 3D information for the virtual subject, which is obtained by the 3D-information obtaining unit, the virtual-image generating unit generates the virtual acquisition image by applying a three-dimensional shape model that is defined in advance according to the type of the subject.

8. An image acquisition system according to claim 1, further comprising an angle-change guiding unit that prompts, if there is missing 3D information in the 3D information for the virtual subject, which is obtained by the 3D-information obtaining unit, a change to a real angle for interpolating the missing 3D information.

9. An image acquisition system according to claim 6, further comprising a change information generating unit that generates information about the direction in which the angle of the image acquisition unit is changed, on the basis of the real angle, which is detected by the real-angle detecting unit, and the virtual angle, which is generated by the virtual-angle generating unit, and that displays the generated information on the display unit.
